(19) United States
(12) Patent Application Publication
(10) Pub. No.: US 2003/0110502 A1
(43) Pub. Date: Jun. 12, 2003

(54) System and method for automatically configuring TV to present programs on viewer-defined playlist

(75) Inventors: Anthony Lionel Creed, San Diego, CA (US); Greg Gudorf, San Diego, CA (US); Aaron Dew, San Diego, CA (US); Matthew Chang, San Diego, CA (US); Rolf Toft, San Francisco, CA (US)

Correspondence Address: John L. Rogitz, Rogitz & Associates, 750 B Street, Suite 3120, San Diego, CA, 92101, US

(73) Assignees: SONY CORPORATION, Toyko (JP); SONY ELECTRONICS INC., Park Ridge, NJ (US)

(21) Appl. No.: 10/000,625

(22) Filed: Oct. 31, 2001

(51) Int. Cl. H04N 7/173

(52) U.S. Cl. 725/86; 725/87

(57) ABSTRACT

A system and method for allowing a viewer to generate a playlist of favorite programs with broadcast times using a remote control, for automatically tuning a TV to the programs on the playlist at the appropriate times. The playlist can be stored on a removable media.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, in a lean back experience, it might be desirable to enable a viewer to essentially program a TV with a list of preferred programs so that the TV will automatically tune to the proper stations at the proper times. This alleviates the need for the viewer to remember when his or her favorite programs are broadcast. It also alleviates the need for the viewer to “channel surf” to find a favorite program. The present invention seeks to address one or more of the issues noted above.

### SUMMARY OF THE INVENTION

A method for automatically presenting TV programs on a TV includes receiving viewer input that establishes a playlist that might potentially be stored on a removable media. The input includes viewer-selected programs or channels that have respective broadcast times which are later than the time the playlist is input. The TV is automatically tuned to the program or channel at the broadcast time without further viewer control. The viewer input can include plural channels and respective broadcast times, or it can include plural programs, with the microprocessor automatically correlating the programs to respective channels and broadcast times.

In a preferred embodiment, the viewer input is received from a wireless input device such as a TV remote control that communicates with the TV. The viewer input establishes a playlist that is accessible by a microprocessor to automatically tune the TV. In one embodiment, the microprocessor is housed in the TV and the playlist on a removable media. In another embodiment, the microprocessor and playlist are housed in a TV remote control device, and the viewer input is generated by a viewer manipulating the remote control device. If desired, the playlist is stored on a removable media that is removably engageable with the remote control device.

In another aspect, a system for enabling a TV viewer to establish a playlist for a TV includes a TV and a remote control device associated with the TV. In accordance with this aspect of the invention, the remote control device receives viewer input that establishes a playlist of at least one program having an associated channel and broadcast time. The remote control device automatically tunes the TV to the channel at the broadcast time.

In still another aspect, a TV system includes a TV tuner, a TV display coupled to the tuner, and a microprocessor automatically configuring the tuner to display a program on the TV display at a broadcast time. In another aspect, other program reference data such as VCR plus code may be used.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of a first embodiment of the system of the present invention, showing the microprocessor in the TV and the playlist potentially stored on removable media;

FIG. 2 is a block diagram of a second embodiment of the system of the present invention, showing the playlist in the remote control; and

FIG. 3 is a flow chart of the inventive logic herein.

### DETAILED DESCRIPTION OF THE PREFERRED EMBODIMENTS

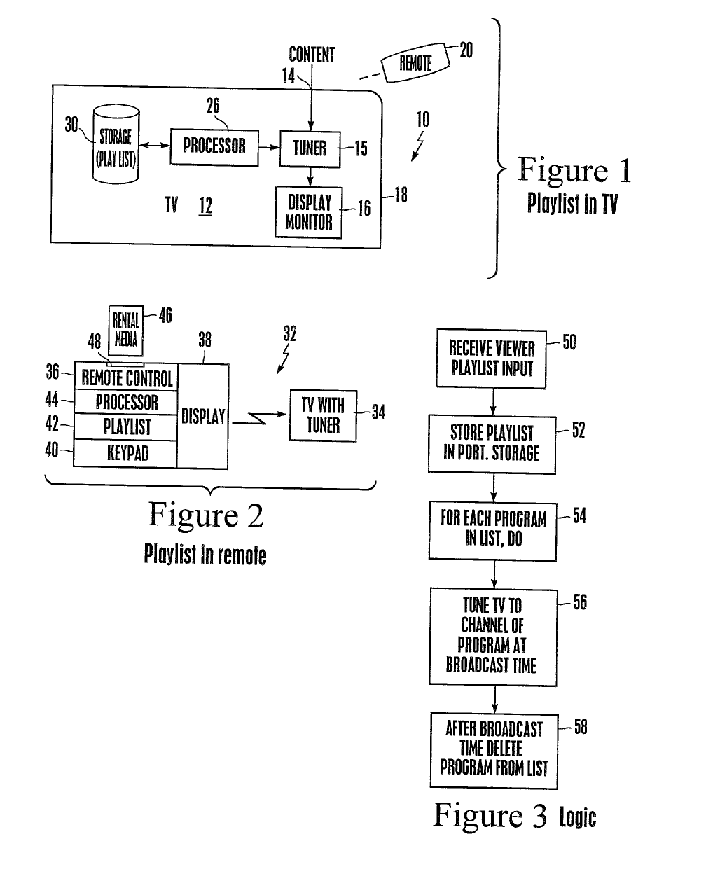

Referring initially to FIG. 1, a system is shown, generally designated 10. As shown, the system 10 includes a TV 12 that conventionally receives televised content at a content receiver 14 (e.g., an antenna, satellite dish, set-top box, etc.), with a channel being selectable by means of a conventional tuner 15 for display of the content on a monitor 16.

While the embodiment of FIG. 1 shows a TV 12 with a single housing that includes a microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds the conventional television tuner 15 which receives the TV signals. One or more viewer input devices, such as but not limited to a wireless TV remote control device 20, can be used to input the below-described playlist to the processor discussed below.

More particularly, a microprocessor 26 communicates with the TV circuitry for presenting programs on a viewer-defined playlist in accordance with the disclosure below. As intimated above, the microprocessor 26 can be located in the housing 18 or it can be disposed elsewhere, such as in a set-top box, remote control device (as shown in FIG. 2 and discussed further below), or other component. In any case, the microprocessor 26 executes the logic set forth herein. The microprocessor 26 can also access a playlist database 30 of viewer-input information, with the database 30 being contained in computer memory, or on a hard disk drive, optical drive, solid state storage, tape drive, removable flash memory, or any other suitable data storage medium and potentially accessible to a network such as the Internet.

It is to be understood that the microprocessors disclosed herein control the respective TV tuners to automatically present TV channels at broadcast times in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

FIG. 2 shows an alternative system 32 that includes a conventional TV with tuner 34 and a remote control device 36. The remote control device 36 has a display 38, such as an LCD or LED display, that a viewer can look at while inputting the playlist of the present invention using a keypad 40 that preferably has keys corresponding to letters in the alphabet, as well as numerals. Other input devices such as jog-dials can be used. Using the keypad, the viewer inputs information that establishes a playlist 42 inside the remote control device 36. A microprocessor 44 within the remote control device 36 accesses the playlist 42 to generate a remote control signal to the TV 34 to automatically tune to a channel corresponding to a program in the playlist at the respective broadcast time. If desired, the playlist 42 can be stored on a removable media 46, such as but not limited to a Sony Memory Stick® or Smart File® which is removably engageable with a slot 48 in the remote control device 36 or with a suitably configured TV receptacle. In this way, playlists can be exchanged between remote control devices of various viewers. It is to be understood that the microprocessor 44 of the remote control device 36 includes a date/time clock. Another embodiment may be implemented with a portable remote control device with embedded playlist memory.

FIG. 3 shows the present logic. Commencing at block 50, viewer input is received when the viewer appropriately manipulates the remote control device 20, 36. The viewer input includes one or more TV programs, e.g., by name, or one or more TV channels, by number. In one embodiment, the viewer inputs (by means of, e.g., the keypad 40 shown in FIG. 2) the name of the desired programs, and the microprocessor 26, 44 accesses a database of programs to correlate the programs with respective TV channels and broadcast times. This can be by program title, VCR Plus® code, etc. In another embodiment, the viewer inputs channels and broadcast times to establish the playlist. In any case, the respective broadcast times are later than the time the playlist is input. When done using the embodiment shown in FIG. 2, the playlist can be displayed on the display 38.

Moving to block 52, the playlist is stored in the TV 12 or remote control device 36. This includes storing the playlist on a removable media and engaging the media with the device 36 or TV 12. At block 54, a DO loop is entered automatically for each program in the list when, e.g., the remote control device 20, 36 is manipulated or at the broadcast time for the program. Moving to block 56, the TV 12, 34 is automatically tuned to the channel associated with the program in the playlist at the respective broadcast time by the respective microprocessor 26, 44. At block 58, after the broadcast time the program/channel can be deleted from the playlist by the respective microprocessor 26, 44.

While the particular SYSTEM AND METHOD FOR AUTOMATICALLY CONFIGURING TV TO PRESENT PROGRAMS ON VIEWER-DEFINED PLAYLIST as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A method for automatically presenting TV programs on a TV, comprising:
receiving viewer input establishing a playlist, the input including at least one viewer-selected program or channel having a broadcast time later than an input time; and
automatically tuning the TV to the program or channel at the broadcast time without further viewer control.

2. The method of claim 1, wherein the viewer input is received from a wireless input device communicating with the TV.

3. The method of claim 1, wherein the viewer input includes plural programs or channels each having a respective broadcast time, the viewer input establishing a playlist accessible by a microprocessor to undertake the automatically tuning act.

4. The method of claim 3, wherein the microprocessor and playlist are housed in the TV.

5. The method of claim 3, wherein the microprocessor and playlist are housed in a TV remote control device, and the viewer input is generated by a viewer manipulating the remote control device.

6. The method of claim 3, comprising removing a program or channel from the playlist after the respective broadcast time.

7. The method of claim 5, comprising storing the playlist on a removable media engageable with the remote control device or TV.

8. The method of claim 3, wherein the viewer input includes plural channels and respective broadcast times.

9. The method of claim 3, wherein the viewer input includes plural programs, the microprocessor correlating the programs to respective channels and broadcast times.

10. A system for enabling a TV viewer to establish a playlist for a TV, comprising:
a TV; and
a remote control device associated with the TV,
the remote control device receiving viewer input establishing a playlist of at least one program having an associated channel and broadcast time, the remote control device automatically tuning the TV to the channel at the broadcast time.

11. The system of claim 10, further comprising a processor supported in the remote control device and communicating with the playlist.

12. The system of claim 11, further comprising a removable media storing the playlist, the removable media being removably engaged with the remote control device.

13. The system of claim 10, wherein the remote control device includes a display.

14. The system of claim 10, wherein the remote control device includes an alpha-numeric keypad including letters of the alphabet.

15. The system of claim 10, wherein the playlist comprises at least one of: plural programs, and plural channels having respective broadcast times.

16. A TV system, comprising:
a TV tuner;
a TV display coupled to the tuner;
a microprocessor automatically configuring the tuner to display a program on the TV display at a broadcast time.

17. The system of claim 16, further comprising a playlist of at least one of: plural programs, and plural channels, each having an associated broadcast time, the microprocessor accessing the playlist to configure the tuner to present a channel at a respective broadcast time.

18. The system of claim 17, further comprising a TV remote control device, wherein the playlist is generated using the TV remote control device.

19. The system of claim 18, wherein the playlist is stored in the remote control device.

20. The system of claim 19, wherein the playlist is stored on a removable media removably engaged with the remote control device or TV.

21. The system of claim 17, wherein the playlist and processor are in the TV.
